(19) United States
(12) Patent Application Publication
(10) Pub. No.: US 2011/0048208 A1
(43) Pub. Date: Mar. 3, 2011

(54) DRIVE MECHANISM

(76) Inventors: Gareth Davies, Bridgend (GB); Simon Bathard, Bridgend (GB); Grant Riley, Pontypridd (GB)

(21) Appl. No.: 12/706,083

(22) Filed: Feb. 16, 2010

(30) Foreign Application Priority Data
Aug. 26, 2009 (GB) 0914830.5

(51) Int. Cl. B26D 5/08

(52) U.S. Cl. 83/633

(57) ABSTRACT

A drive mechanism for a hole punch includes a frame and a lever having a first end and a second end. The lever is pivotally coupled to the frame at a pivot point disposed intermediate the first and second end thereof. The frame includes a lever engaging portion for engaging with a frame engaging portion disposed at the second end of the lever, such that as the first end of lever is pivoted about the pivot point, the frame engaging portion is arranged to move along the lever engaging portion to cause the pivot point to move with respect to the frame.

### BACKGROUND OF THE INVENTION

1. Technical Field of the Invention

The present invention relates to a drive mechanism and particularly, but not exclusively to a drive mechanism for a hole punch.

2. Description of the Prior Art

U.S. Patent Application Publication No. 2006/0117927 discloses a hole punch comprising a frame and a handle which is arranged to pivot with respect to the frame. The handle comprises a plurality of teeth disposed upon a pinion at a lower end thereof. The pinion is arranged to engage with a plurality of teeth disposed upon a rack, such that as the handle is pivoted with respect to the frame, the rack becomes driven by the pinion which drives a punching arm into a sheet of paper, for example.

However, in order to drive the rack and thus the punching arm, the handle is rotated from one side of the frame, over the frame to the other side. This movement is found to lift the hole punch and cause the hole punch to slide upon the surface on which it is placed, with the result that the hole punch can move with respect to the sheet of paper. Accordingly, it is difficult to stabilize the punch while maintaining the correct alignment of the sheet.

### SUMMARY OF THE INVENTION

In accordance with a first aspect of the present invention there is provided a drive mechanism for a hole punch, the mechanism comprising a frame and a lever comprising a first end and a second end, the lever being pivotally coupled to the frame at a pivot point disposed intermediate the first and second end thereof,
the frame comprising a lever engaging portion for engaging with a frame engaging portion disposed at the second end of the lever, wherein,
as the first end of the lever is pivoted about the pivot point, the frame engaging portion is arranged to move along the lever engaging portion to cause the pivot point to move with respect to the frame.

The movement of the pivot point with respect to the frame only requires the handle to move through a small angular range in order to provide the required travel on the punching arm. The lever thus remains at one side of the frame throughout its range of motion.

The pivot point is preferably arranged to move along a channel which extends substantially parallel to the lever engaging portion.

Preferably, the lever engaging portion comprises a first plurality of formations and the frame engaging portion comprises a second plurality of formations. The first and second plurality of formations preferably provide a fulcrum for the lever, which is arranged to move along the lever and frame engaging portions. Preferably, the first and second plurality of formations are complimentary formations.

The lever engaging portion preferably comprises a substantially linear arrangement of first formations. The frame engaging portion preferably comprises a substantially arcuate arrangement of second formations.

Preferably, the distance between the pivot point and the first end of the lever is greater than the distance between the pivot point and the second end of the lever. This provides the required mechanical advantage for the user in punching a hole in, for example, a number of sheets of paper simultaneously.

The drive mechanism preferably further comprises a punching arm which is arranged to move with the pivot point and which is arranged to punch a hole in a sheet of paper, for example.

The first end of the lever is preferably disposed to one side of the pivot point with respect to the frame and preferably remains at the one side throughout the range of motion of the lever.

Preferably, the frame comprises a slot for receiving material in which it is intended to punch a hole. The lever is preferably pivotable between a first configuration in which the punching arm is removed from the slot and a second configuration in which the punching arm extends within the slot.

In accordance with a second aspect of the present invention there is provided a hole punch comprising the drive mechanism of the first aspect.

Other objects and features of the present invention will become apparent when considered in combination with the accompanying drawing figures which illustrate certain preferred embodiments of the present invention. It should, however, be noted that the accompanying drawing figures are intended to illustrate only certain embodiments of the claimed invention and are not intended as a means for defining the limits and scope of the invention.

### BRIEF DESCRIPTION OF THE DRAWING FIGURES

In the drawing, wherein similar reference numerals and symbols denote similar features throughout the several views:

FIG. 1a is perspective view of a drive mechanism according to an embodiment of the present invention, in a first configuration;

FIG. 1b is perspective view of a drive mechanism of FIG. 1a, in a second configuration;

FIG. 2a is a side view of the drive mechanism of FIG. 1a;

FIG. 2b is a side view of the drive mechanism of FIG. 1b; and

FIG. 3 is an exploded view of a hole punch comprising the drive mechanism of FIG. 1 or 2.

### DETAILED DESCRIPTION OF THE DRAWING FIGURES AND PREFERRED EMBODIMENTS

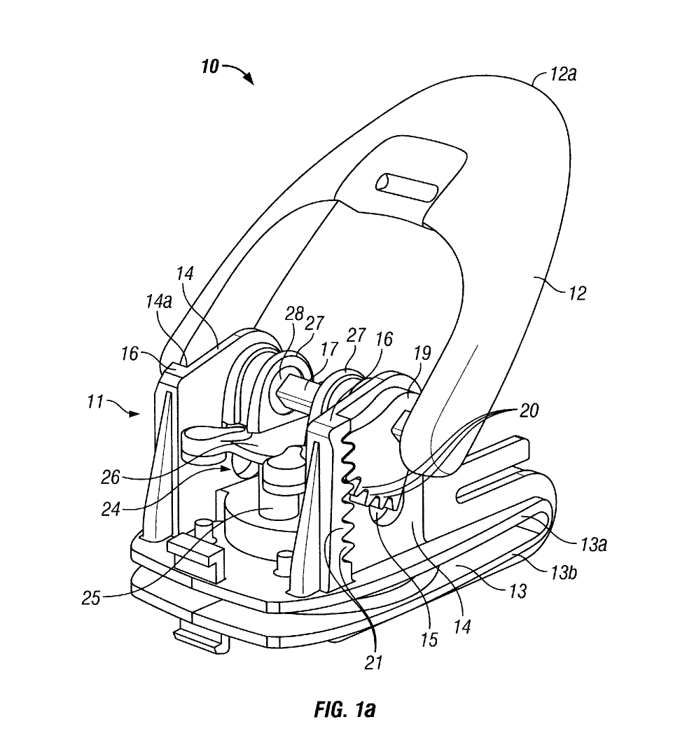

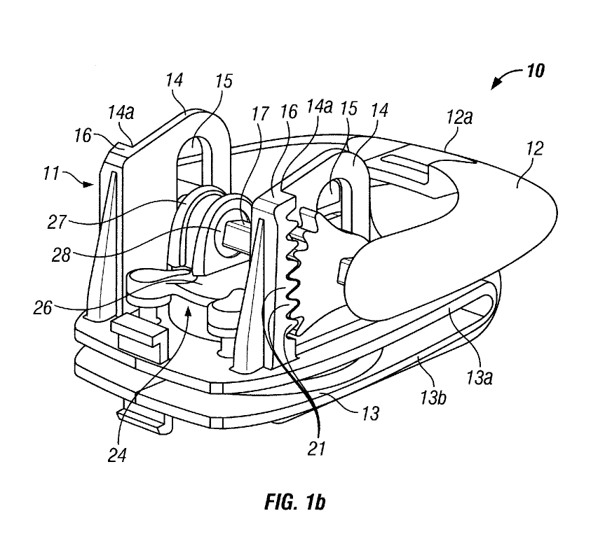

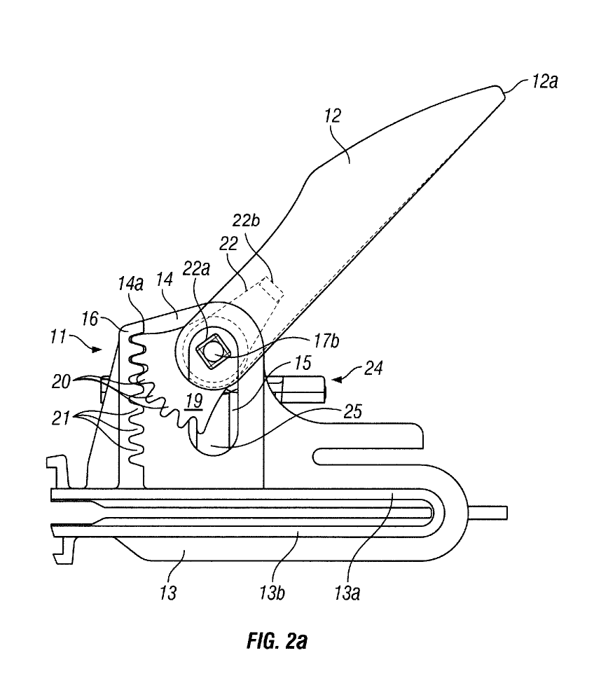

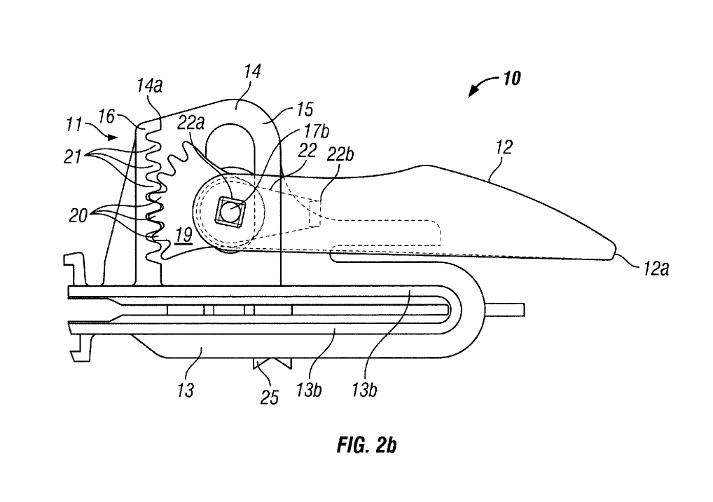

Referring to FIGS. 1 to 3 of the drawings, there is illustrated a drive mechanism 10 for a hole punch 100 according to an embodiment of the present invention. The drive mechanism 10 comprises a frame 11 and a handle 12 pivotally mounted with respect to the frame 11. The frame 11 comprises a base 13 that is substantially C-shaped in longitudinal cross-section (as illustrated in FIG. 2) and comprises an upper, substantially planar base level 13a and a lower, substantially planar base level 13b. The frame 11 further comprises a pair of substantially planar support pillars 14 which extend from the upper base level 13a, in a direction substantially perpendicularly thereto.

The support pillars 14 are disposed upon the base 13, either side of a longitudinal axis thereof and are orientated substantially parallel to each other and the longitudinal axis, such that the frame 11 is substantially symmetric about the longitudinal axis. Each pillar 14 comprises an elongate channel 15 which extends through the pillar 14, along a length of the pillar 14, and a flange 16 which extends along the length of the pillar 14 at a forward edge 14a thereof. Each flange 16 is turned outwardly away from the longitudinal axis and extends in a direction substantially parallel to the channel 15 formed in the adjacent pillar 14. In the embodiment illustrated, each flange 16 and channel 15 extend substantially perpendicularly to the upper level 13a of the base 13.

The drive mechanism 10 further comprises a pivot rod 17 which extends between each pillar 14 and through each elongate channel 15. The pivot rod 17 is prevented from moving out from the elongate channel 15 within the support pillars 14, by a pair of C-shaped clips 18 one of which is arranged to pass over the rod 17 at the side of each pillar 14 that is opposite the side proximate to the longitudinal axis.

The free ends 17a, 17b of the rod 17 separately comprise a drive plate 19 having an aperture 19a disposed at one end thereof for receiving a free end of the rod 17 and a substantially arcuate edge 19b disposed at the opposite end thereof. The arcuate edge 19b of each drive plate 19 comprises a plurality of teeth 20 which are arranged to separately engage between a plurality of teeth 21 disposed on a rear facing portion of each flange 16. The teeth 21 disposed on each flange 16 are of substantially complimentary size and shape to the teeth 20 formed on the drive plates 19 and extend along the length of the flange 16. The pivot rod 17 is substantially square in cross-section and the aperture 19a formed in each drive plate 19 is of similar size and shape to the cross-section of the pivot rod 17 such that as the pivot rod 17 rotates within the channel 15, the drive plate 19 is caused to rotate. The interlocking teeth 20, 21 provide a fulcrum for the handle 12, such that as the handle 12 is pivoted with respect to the frame 11, the fulcrum travels along the respective flange 16 causing the pivot rod 17 to move along the channels 15.

The handle 12 is substantially U-shaped and arranged to extend to either end 17a, 17b of the pivot rod 17. Each end of the handle 12 is separately coupled to one end of the pivot rod 17 by a locking plate 22. The locking plates 22 are housed within a depression 23 formed at each end of the handle 12 and comprise a substantially square aperture 22a for receiving a free end 17a, 17b of the rod 17. The depressions 23 are of substantially complimentary shape and size to the locking plates 22 and thus prevent any rotation of the plate 22 with respect to the handle 12. The plates 22 further comprise a barb 22b which is arranged to locate within a locking recess 23a formed within the depression 23 and thus further serve to prevent any rotation of the plate 22 with respect to the handle 12. The barbs 22b on the locking plates 22 and the depressions 23 formed within the handle 12 thus lock the rotation of the pivot rod 17 to the handle 12 such that as the handle 12 is pivoted with respect to the frame 11, the pivot rod 17 is caused to rotate within the channels 15.

The drive mechanism 10 further comprises a mounting 24 for one or more punching arms 25 which are arranged to punch a hole in a sheet of paper, or metal (not shown), for example. The mounting 24 is disposed between the pillars 14 and comprises a plate 26 having a pair of eyelets 27 disposed on an upper side thereof for receiving the pivot rod 17. The one or more punching arms 25 extend from the underside of the plate 26 and are arranged to extend through aligned apertures (not shown) formed in the upper and lower levels 13a, 13b of the base 13 of the frame 11. The eyelets 27 comprise a substantially cylindrical internal passage and an internal collar 28 disposed therein, which is arranged to rotate within the respective passage. Each collar 28 comprises a substantially cylindrical outer surface and an inner aperture that is substantially square in cross-section, and is rigidly coupled to the respective drive plate 19 so that the inner aperture of each collar 28 is substantially aligned with the respective aperture 19a in the drive plate 19. The collars 28 are arranged to receive the pivot rod 17 and enable the rod 17 to freely rotate within the respective eyelet 27 without causing any rotation of the mounting 24.

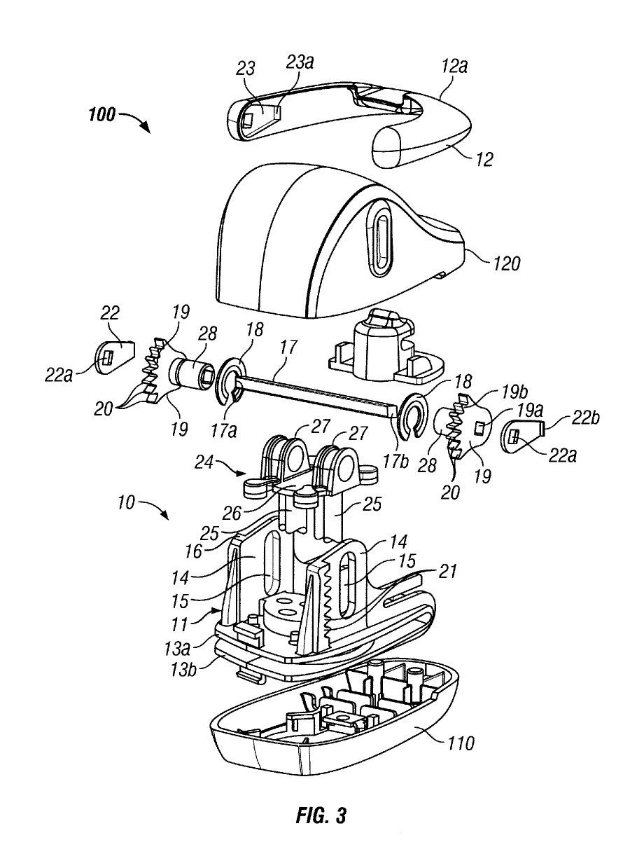

Referring to FIG. 3 of the drawings, there is illustrated an exploded view of a hole punch 100 comprising the drive mechanism 10 illustrated in FIGS. 1 and 2. The lower level 13b of the base 13 of the frame 11 of the drive mechanism 10 is removably coupled within a receptacle 110, which serves to retain the material removed during the punching process. The pillars 14 and mounting 24 are housed within a shroud 120 which is removably coupled to an upper level 13a of the frame base 13.

In use, the material, for example sheets of paper or metal (not shown) or similar that requires a hole or holes to be punched therein, is placed within the base 13 of the frame 11 between the upper 13a and lower levels 13b thereof and suitably aligned with respect to the punching arms 25. The handle 12 is then pivoted from an orientation in which it extends over a rear of the base 13 at an acute angle thereto, toward the base 13. As the handle 12 is pivoted downwardly, the pivot rod 17 is rotated with respect to the frame 11 and the drive plates 19 are caused to travel from an upper region of the respective flanges 16 toward the base 13. During this motion of the handle 12, the pivot rod 17 moves along the channels 15 in the pillars 14 and thus advances the mounting 24 toward the base 13. The force subjected to the handle 12 is principally directed downward toward the base 13 of the hole punch 100 and thus toward the surface (not shown) upon which the hole punch 100 is placed. This ensures that the hole punch 100 remains substantially stationary as the handle 12 is pivoted.

As the mounting 24 is moved toward the base 13, the punching arms 25 move into the space between the upper and lower levels 13a, 13b of the base 13 and thus into the material (not shown). The pivot rod 17 is coupled to the handle 12 at a position such that the distance between the pivot rod 17 and the arcuate edge 19b of the drive plate 19 is less that the distance between the pivot rod 17 and the distal end 12a of the handle 12. This provides the operator (not shown) with a mechanical advantage which enables the operator (not shown) to punch through several sheets of paper (not shown) simultaneously for example, or a particularly thick sheet of paper, for example, with minimal downward force.

The punching arms 25 are arranged to pass through the aligned apertures (not shown) in the upper and lower levels 13a, 13b of the base 13 such that the material removed during the punching process becomes ejected into the receptacle 110. Upon releasing the handle 12, a coil spring (not shown) causes the handle 12 and thus the mounting 24 to return to their initial orientation. As the mounting 24 returns to its initial position the punching arms 24 become removed from between the upper and lower levels 13a, 13b of the base 13, and thus the material, so that the material can be removed from the punch.

While the drive mechanism 10 of the present invention has been exemplified through its incorporation in a hole punch 100, it is envisaged that the mechanism 10 would also find suitable application in cutting devices (not shown), for example. From the foregoing therefore, it is evident that the drive mechanism of the present invention provides for a simple yet effective means of driving a cutting blade or punching arm into a material.

While only several embodiments of the present invention have been shown and described, it will be obvious to those skilled in the art that many modifications may be made to the present invention without departing from the spirit and scope thereof.

What is claimed is:

1. A drive mechanism for a hole punch, comprising:
a frame and a lever comprising a first end and a second end, the lever being pivotally coupled to the frame at a pivot point disposed intermediate the first end and second end thereof, the frame comprising a lever engaging portion for engaging with a frame engaging portion disposed at the second end of the lever, wherein, as the first end of the lever is pivoted about the pivot point, the frame engaging portion moves along the lever engaging portion for causing the pivot point to move with respect to the frame.

2. The drive mechanism according to claim 1, wherein the pivot point moves along a channel extending substantially parallel to the lever engaging portion.

3. The drive mechanism according to claim 1, wherein the lever engaging portion comprises a first plurality of formations and the frame engaging portion comprises a second plurality of formations.

4. The drive mechanism according to claim 3, wherein the first plurality of formations and the second plurality of formations provide a fulcrum for the lever for moving along the lever and frame engaging portions.

5. The drive mechanism according to claim 3, wherein the first plurality of formations and the second plurality of formations are complimentary formations.

6. The drive mechanism according to claim 1, wherein the lever engaging portion comprises a substantially linear arrangement of first formations.

7. The drive mechanism according to claim 1, wherein the frame engaging portion comprises a substantially arcuate arrangement of second formations.

8. A drive mechanism according to claim 1, wherein the distance between the pivot point and the first end of the lever is greater than the distance between the pivot point and the second end of the lever.

9. The drive mechanism according to claim 1, further comprising a punching arm movable with the pivot point and capable of punching a hole.

10. The drive mechanism according to claim 1, wherein the first end of the lever is disposed to one side of the pivot point with respect to the frame and remains at the one side throughout a range of motion of the lever.

11. The drive mechanism according to claim 1, wherein the frame comprises a slot for receiving material in which a hole is intended to be punched.

12. The drive mechanism according to claim 11, wherein the lever is pivotable between a first configuration, in which the punching arm is removed from the slot, and a second configuration in which the punching arm extends within the slot.

13. A hole punch, comprising:
a drive mechanism including:
a frame and a lever comprising a first end and a second end, the lever being pivotally coupled to the frame at a pivot point disposed intermediate the first end and second end thereof, the frame comprising a lever engaging portion for engaging with a frame engaging portion disposed at the second end of the lever, wherein, as the first end of the lever is pivoted about the pivot point, the frame engaging portion moves along the lever engaging portion for causing the pivot point to move with respect to the frame; and,
means for punching a hole in material in which a hole is intended to be punched.
